(19) United States
(12) Patent Application Publication
(10) Pub. No.: US 2002/0011729 A1
(43) Pub. Date: Jan. 31, 2002

(54) Health and immunization record booklet

(76) Inventors: Scott E. Lackey, Flower Mound, TX (US); James R. Jinright, Flower Mound, TX (US); Kenneth R. Burton JR., Houston, TX (US)

Correspondence Address: JOHN E. VANDIGRIFF, 190 N. STEMMONS FRWY., SUITE 200, LEWISVILLE, TX, 75067, US

(21) Appl. No.: 09/894,271

(22) Filed: Jun. 29, 2001

Related U.S. Application Data
(60) Provisional application No. 60/222,020, filed on Jul. 31, 2000.

(51) Int. Cl. B42D 15/00

(52) U.S. Cl. 283/113

(57) ABSTRACT

A pocket size booklet for keeping statical records of a particular person from birth and for keeping records of an adult person. Non-tearing waterproof pages made from a synthetic material are used, and the data is printed, or data is written, on the pages with an indelible ink. The pages include a water mark on each page. Pages may include medical history, physical conditions, surgeries, medications, and vaccination records of a person or child. Pages may be provide on which to place the footprints and fingerprints of a new born child.

### FIELD OF THE INVENTION

The invention relates to records documents, and more particularly to a records document booklet for health and immunization data, the booklet having water proof pages on which the data is transcribed in indelible ink.

### BACKGROUND OF THE INVENTION

Booklets with various type of information exist for recording data. An example of a booklet structure is described in U.S. Pat. No. 6,135,503. Described is a booklet structure in which the data sheet is placed into a laminate only in the area of the data sheet where there is information to be protected. This structure leaves the data sheet in a single layer at the seam where the booklet pages are secured together.

A booklet is described in U.S. Pat. No. 6,089,608, in which the front and back cover have a vinyl pocket on the inside of the front and back covers. A plurality of leaves or pages are then attached inside of the cover.

An emergency medical card is described in U.S. Pat. No. 5,197,763, which consists of a reduced in size printed document that is laminated between plastic sheets.

### SUMMARY OF THE INVENTION

The invention is a pocket size booklet for keeping statistical records of a particular person from birth. It may also be used for keeping records of an adult person. Non-tearing waterproof pages of a synthetic material, for example, Tyvek® are used, and the data is printed, or data is written, on the pages with an indelible ink. The pages include a water mark on each page. Pages may include medical history, physical conditions, surgeries, medications, and vaccination records of a person or child. Pages may be provided on which to place the footprints and fingerprints of a new born child.

### BRIEF DESCRIPTION OF THE DRAWINGS

FIG. 1 illustrates a cover for a Health and Immunization record;

FIG. 2 illustrates a cover for a Childhood Health and Immunization record;

FIG. 3 shows the Health record Table of Contents;

FIG. 4 shows personal information page for a child;

FIG. 5 shows a page for Statistical Information;

FIG. 6 shows a page for a Medical History;

FIG. 7 shows a page for Family Health History;

FIG. 8 shows a page of Family Health History details;

FIG. 9 shows a page for weight and height history;

FIG. 10 shows a page for Medications taken on a regular basis;

FIG. 11 shows a page for genetic testing and hospital newborn screening, including DNA and cord blood;

FIG. 12 shows a page for child developmental milestones;

FIG. 13 shows a page to contain notes;

FIG. 14 shows a page for an infant's left foot print;

FIG. 15 shows a page for an infant's right foot print;

FIG. 16 shows a page for an infant's finger prints;

FIG. 17 shows a page for tuberculosis screening;

FIG. 18 shows a page for Consent to Seek Medical Care;

FIG. 19 shows a page for Specialist and other health providers;

FIG. 20 shows a page of recommended childhood immunizations;

FIG. 21 is a page for summary of immunizations;

FIG. 22 is a page for listing immunizations;

FIG. 23 is an International Certificate of Vaccination against yellow fever;

FIG. 24 is an International Certificate of Vaccination against yellow fever;

FIG. 25 shows instructions for completing the International Certificate of Vaccination;

FIG. 26 list health considerations for traveling abroad;

FIG. 27 provides a place for photos, full face and profile, in the Health Record;

FIG. 28 shows an example for construction of the Health Record Book; and

FIG. 29 shows the watermarks for each of the pages.

### DESCRIPTION OF A PREFERRED EMBODIMENT

The invention is a Health and Immunization book, and it is constructed to provide a record of health, immunization, and other records for a person. In one embodiment, pages are included for records beginning with the birth of a child. If started later in life, then records are provided for an adult. The booklet is constructed on water proof, pages that will not tear, and writing or printing is done with an indelible ink so that information in the booklet becomes permanently affixed, and so water and other substances will not fade the information.

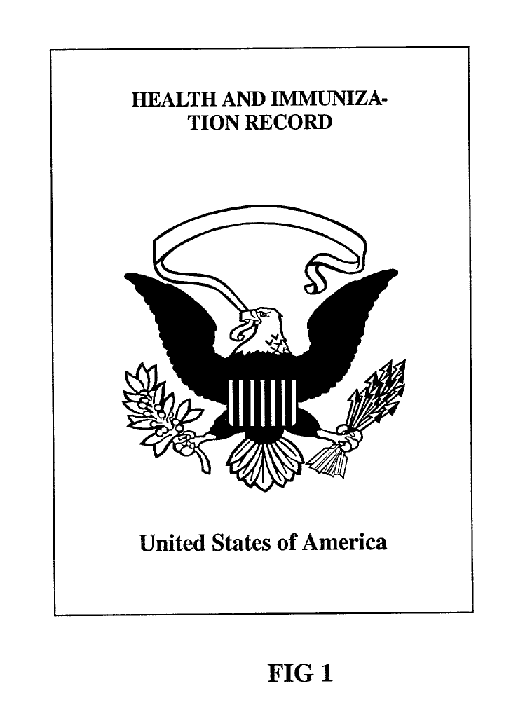

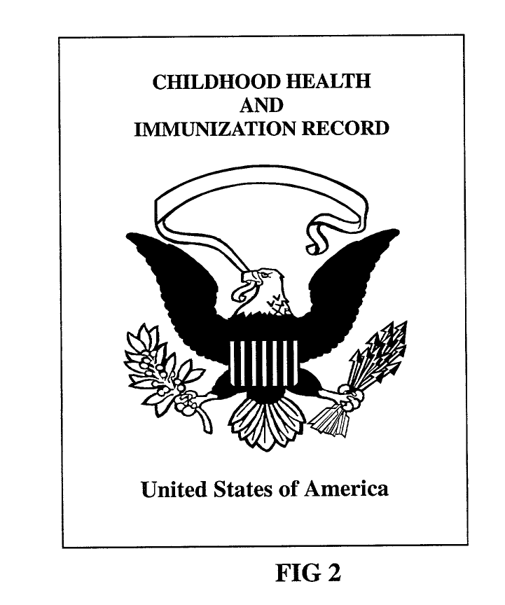

FIG. 1 shows an example of a cover that may be used for a person start at, or after birth. FIG. 2 shows an example of a cover that may be used on a booklet for a child, commencing at, or after birth. While either cover may be utilized, one as illustrated in FIG. 2 would, in a family, indicate a child record, while the cover in FIG. 1 would indicate the booklet used by an adult.

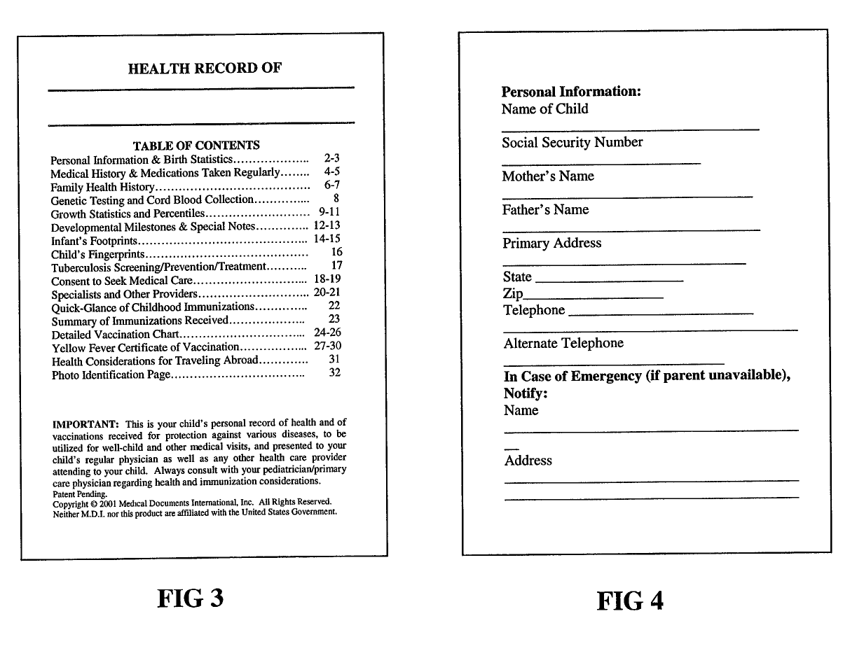

In FIG. 3, is shown an example of a Table Of Contents. This Table of Contents shows, at least in part, the information that may be recorded in the Heath Record Booklet. It provides a list of the basic health information that may be needed for a child to show what immunizations, disease, and other illness that the child may have had.

FIG. 4 list the basic information for the child in relation to residency, parents' names, and at least one name and address for emergency purposes.

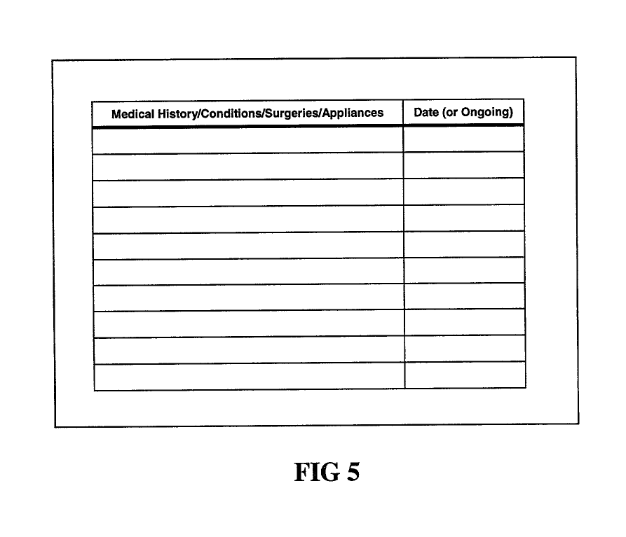

FIG. 5 provides space to list medical history information, special medical conditions of the person, and any appliances used by the person.

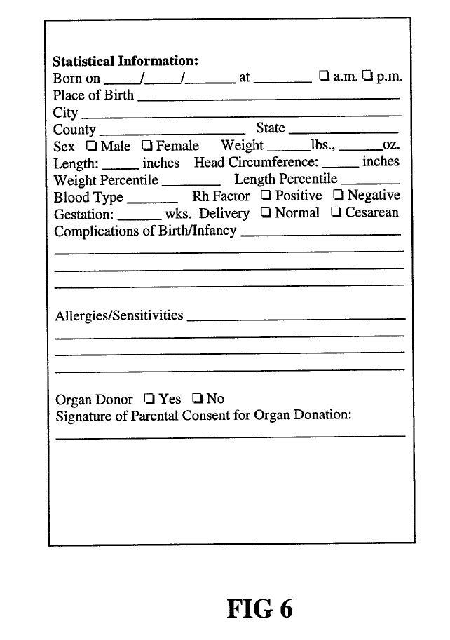

A record of statistical information at birth, and later, is listed on the page illustrated in FIG. 6. It allows recording basic birth information, blood type, and allergies.

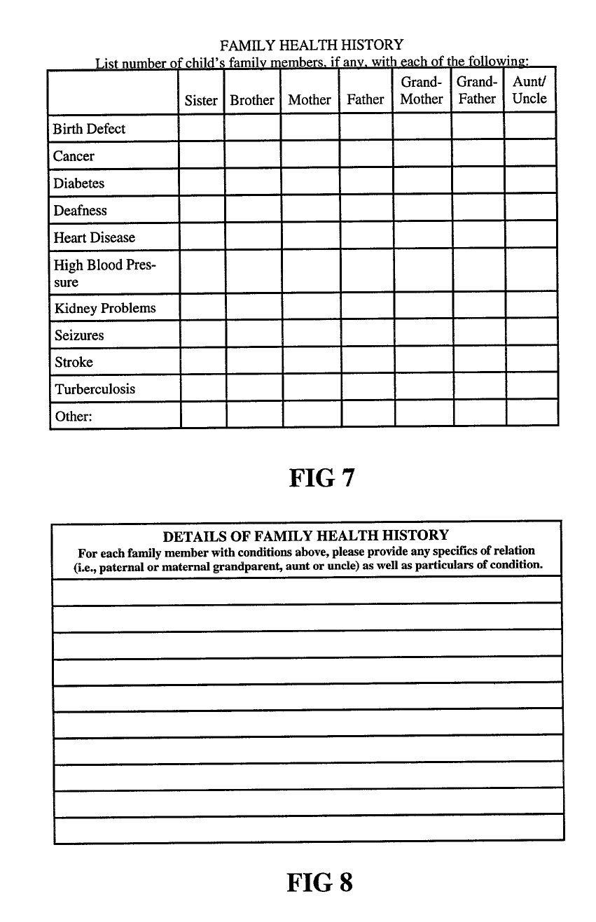

In diagnosing illnesses, it is at times desirable to have a family health history. This may indicate potential health factors of the child. A Family Health History may be listed on the page illustrated in FIG. 7. Space is available for family and grand parent information. To record the details of family health history, a page as illustrated in FIG. 8 may be used.

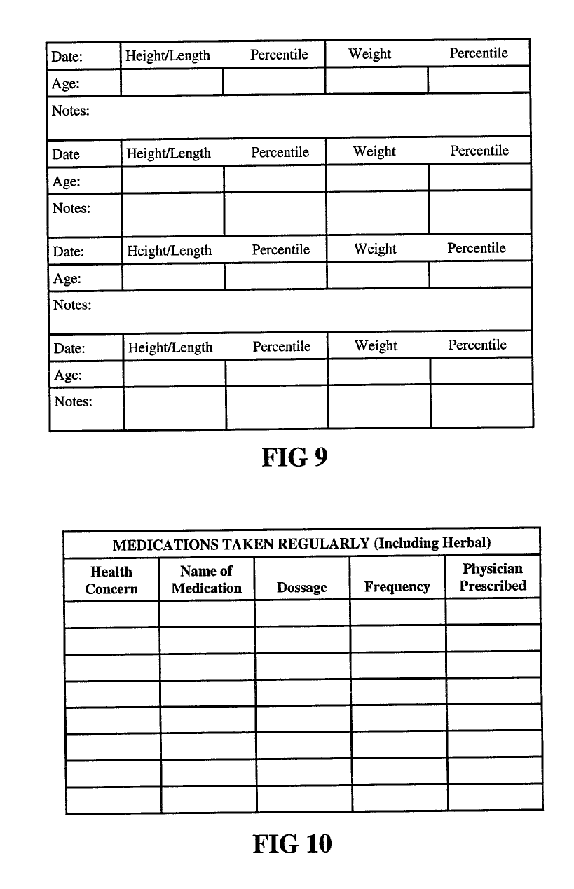

The page of FIG. 9 is for recording height, weight, and national percentile by age. This may be on at least three different ages. Notes may also be recorded.

Physician often inquire into medications taken on a regular basis. In treating a person, it is desirable to know what medications that a person is taking in order to avoid givin other medications that will conflict with previous prescribed medicines. FIG. 10 provides a listing of medications taken on a regular basis.

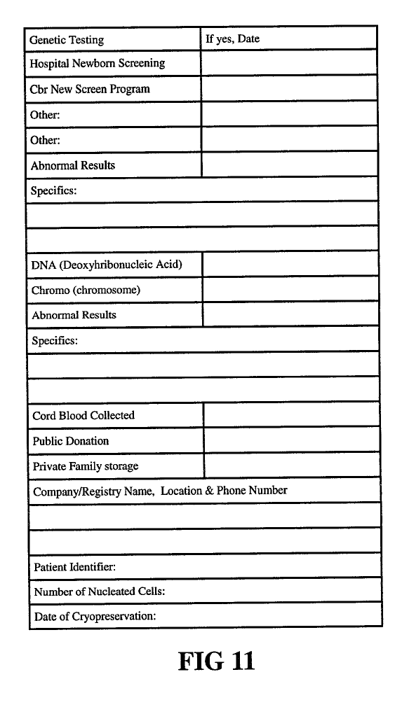

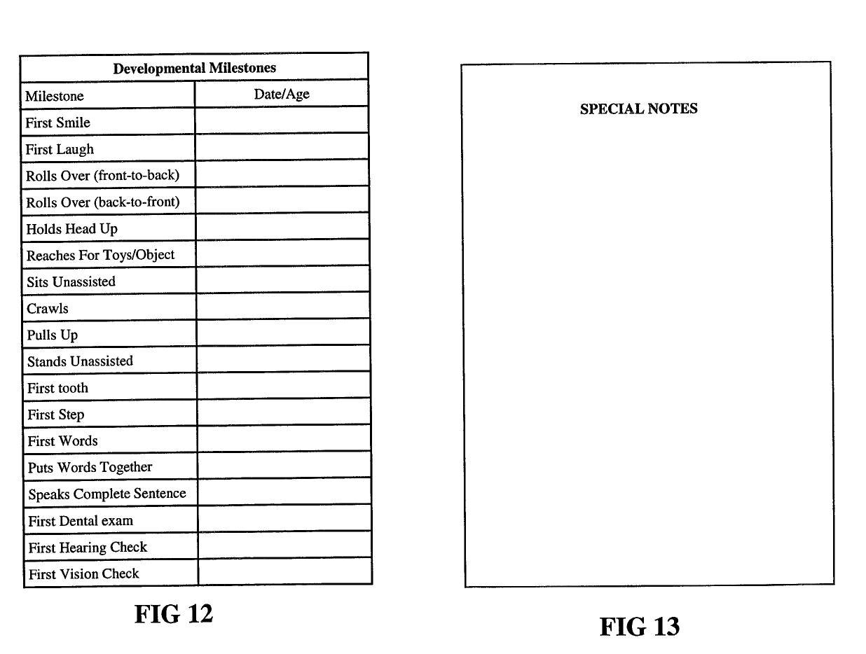

To record genetic testing performed on a person, a page such as that illustrated in FIG. 11 may be used. Further developments of a child are shown in FIG. 12, and special notes may be recorded on the page illustrated in FIG. 13.

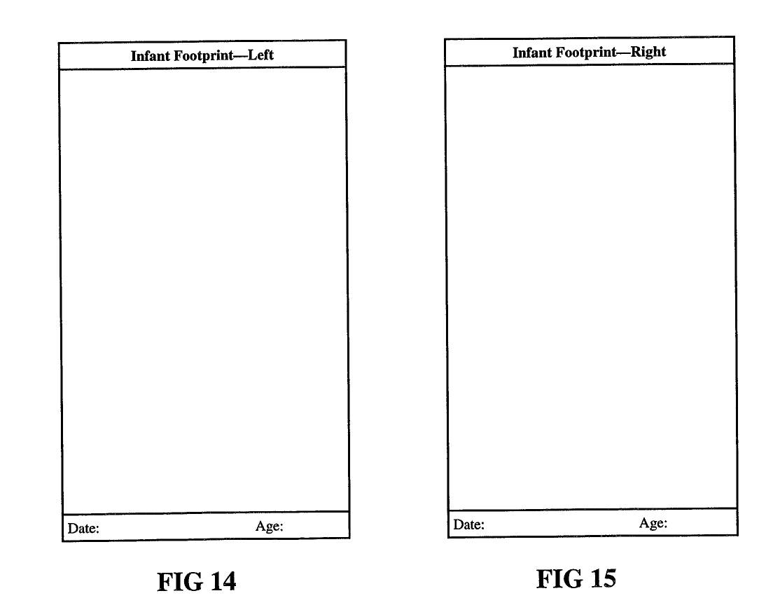

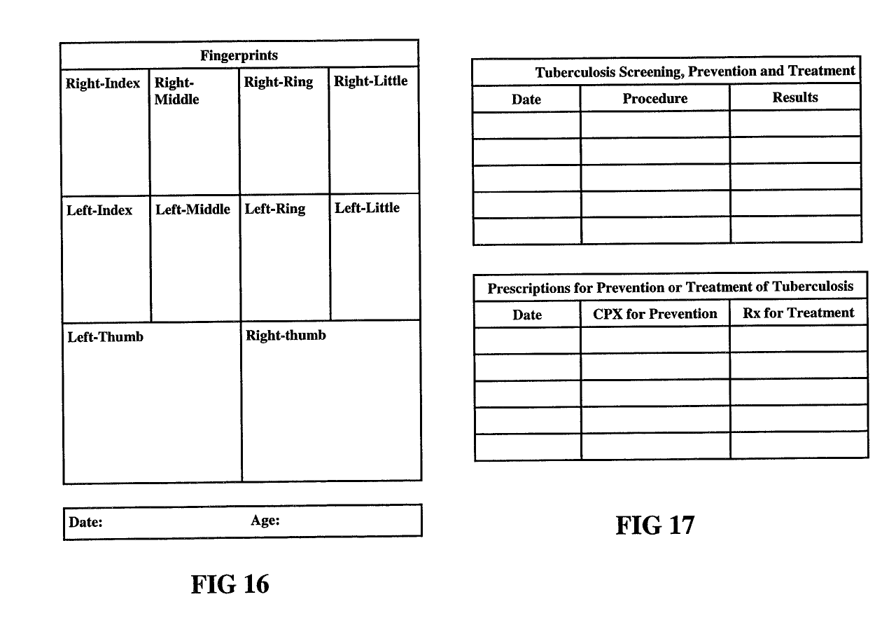

For identification purposes, an infants footprints may be placed on the pages illustrated in FIG. 14 and FIG. 15, and finger prints are recorded on the page illustrated in FIG. 16.

Information regarding tuberculosis, prescriptions given, or preventative for treatment may be recorded on the page illustrated in FIG. 17.

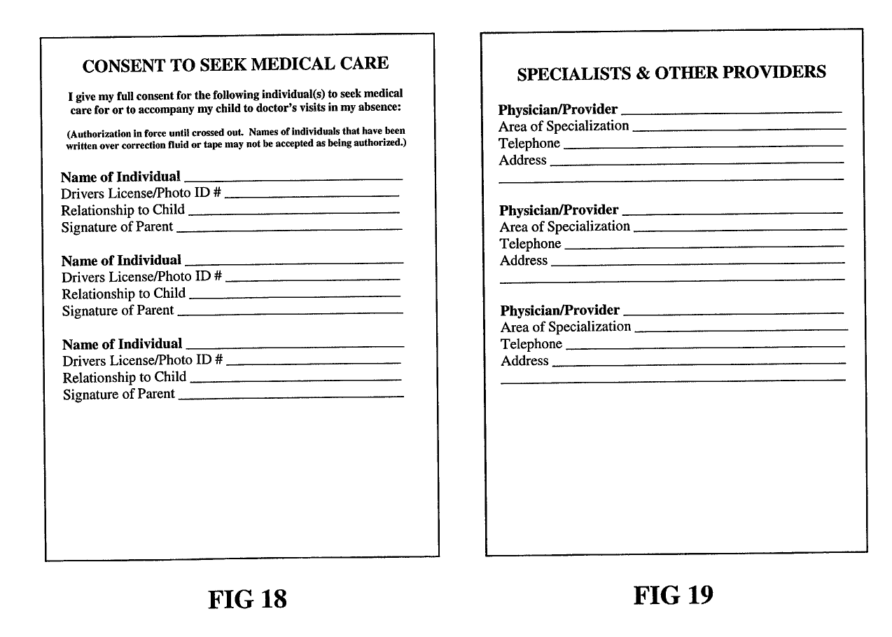

Normally when a parent leaves a child with a family member or other person, a consent paper is given to permit the family member or person to seek medical care for the child if necessary. This consent is listed on the page illustrated in FIG. 18. To accompany the consent, a listing of physicians for treating the child are given in FIG. 19.

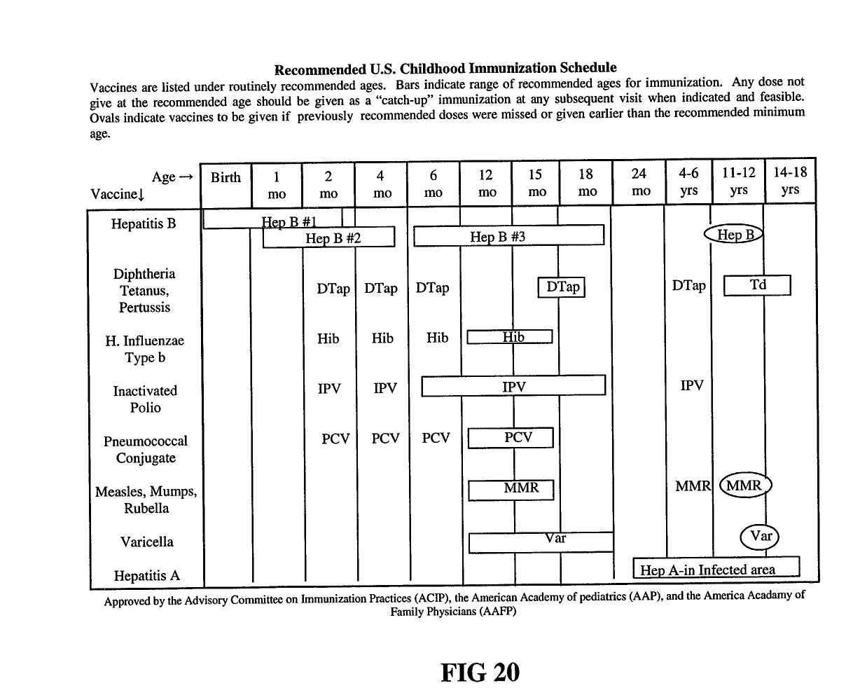

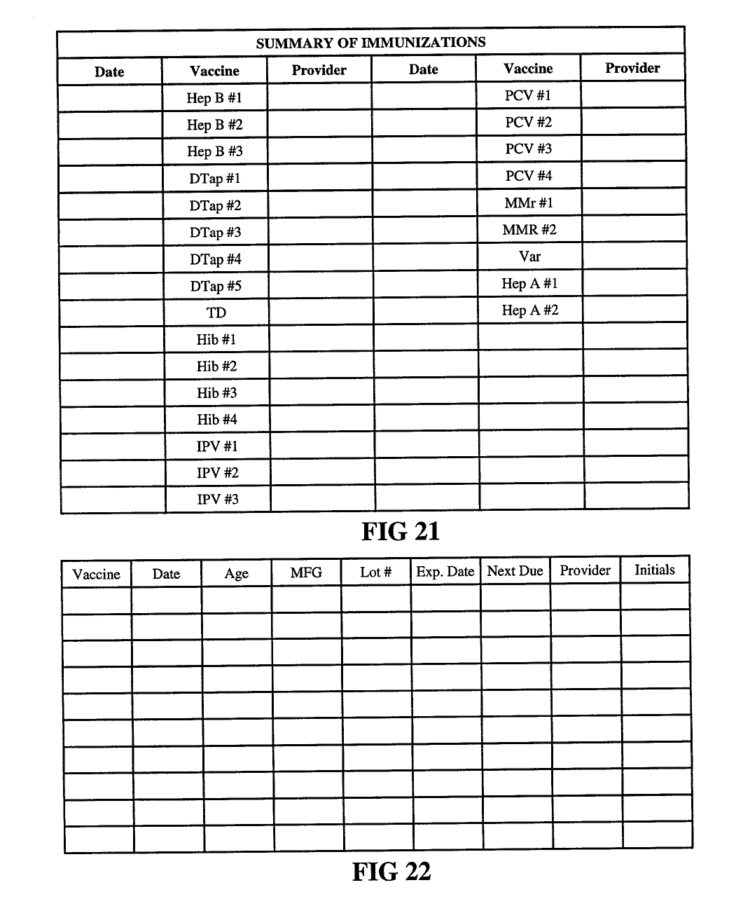

Children, as they are growing up, re required to have a number of immunizations. A suggested or recommended schedule of immunizations are shown in FIG. 20. This listing will help parents to know when it is best to have their child immunized during the child's early life. To maintain a list of immunizations, the pages illustrated in FIG. 21 and FIG. 22 allow listing of dates of immunizations and the vaccines used.

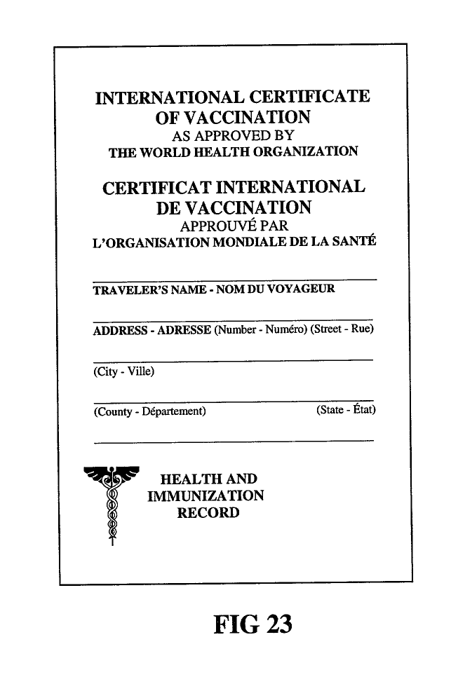

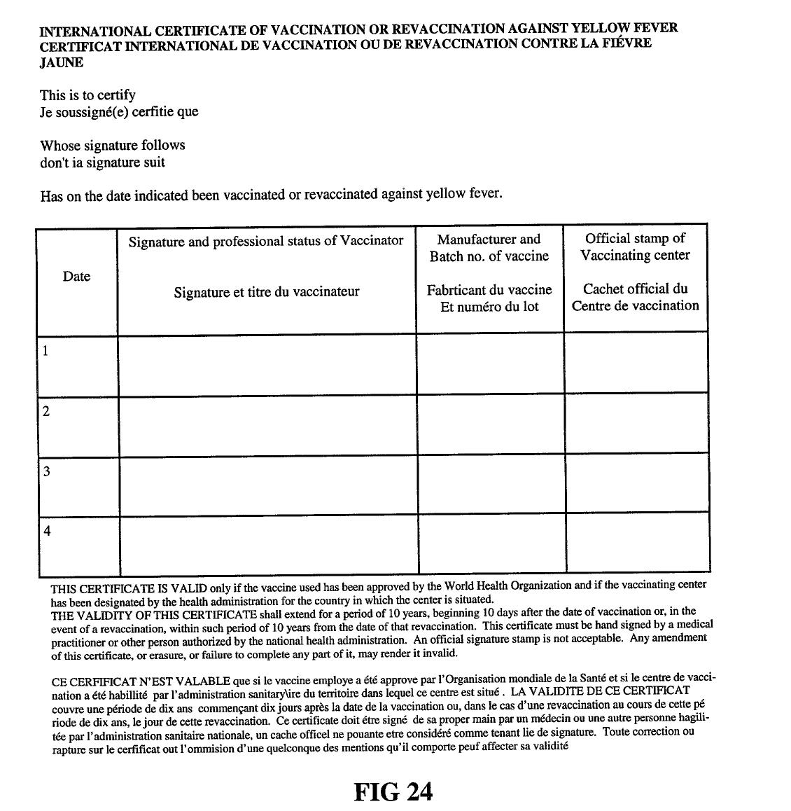

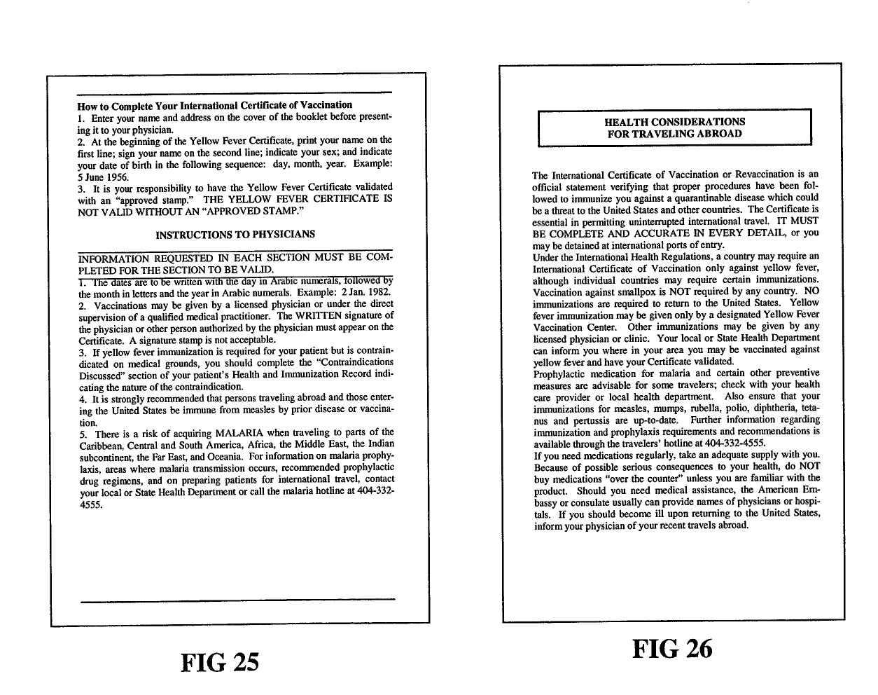

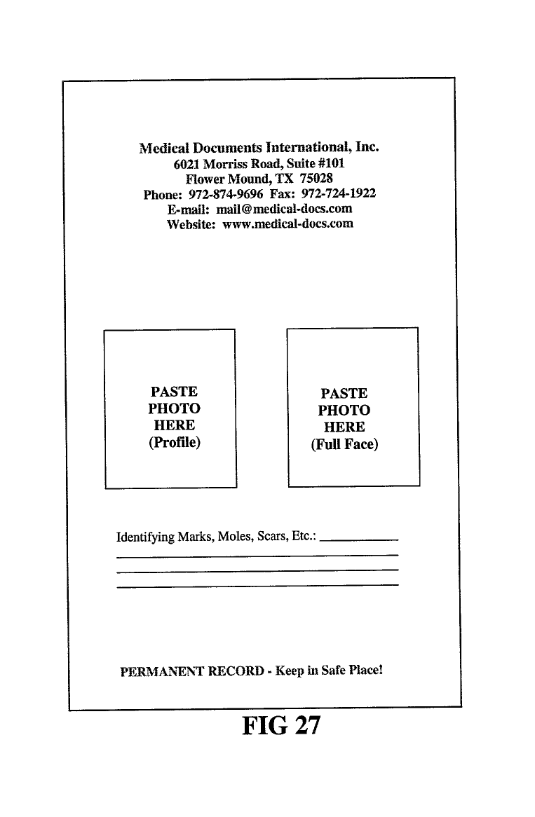

When traveling abroad, it may be necessary to have specific immunizations for traveling to specific countries. A cover traveler information sheet is shown in FIG. 23, and the International Certificate of Vaccination against yellow fever, with instructions, is illustrated in FIG. 24. Instructions how to complete the International Certificate of Vaccination is shown in FIG. 25. Health Considerations for traveling abroad is outlined in FIG. 26. For purposes of identifying the person to whom the booklet belongs, photos and a listing of identifying marks or scars may be inserted in the page illustrated in FIG. 27.

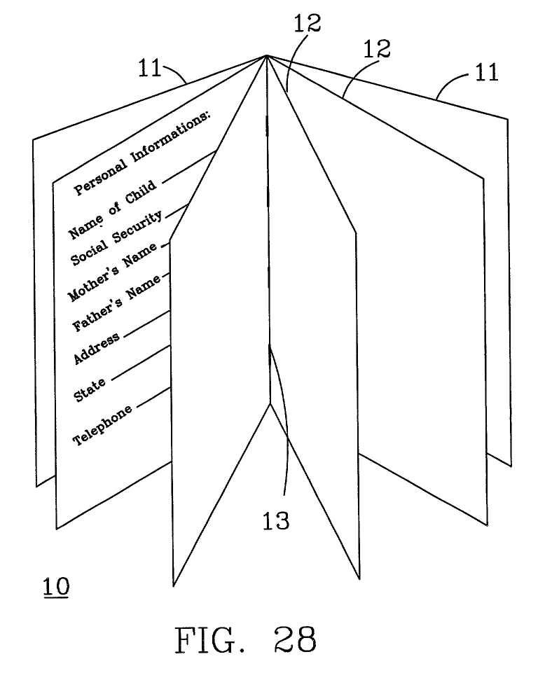

FIG. 28 shows the basic structure of the Health and Immunization Record Booklet 10. The booklet may be constructed using a single saddle fold or may use several signatures. An important feature of the booklet is that the pages are made of a synthetic, non-tearing waterproof material. One example of such a material is the material Tyvek®. To provide a water-proof document, the printing in the booklet is made with a water proof or indelible ink, and the notations inserted in the booklet should also be made with an indelible or water proof ink.

Each page is 12 is secured in a cover 11 by fasteners 13. Fasteners 13 may be staples or a stitching, preferably of a plastic, metallic, or synthetic material.

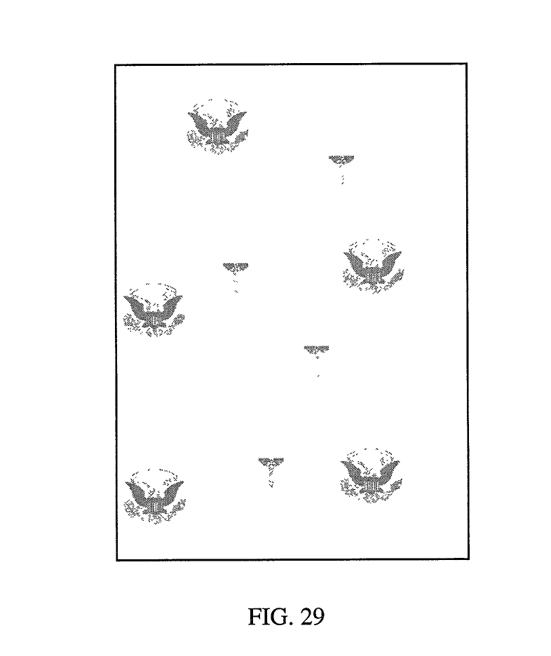

Another feature of the booklet pages is that each page has a watermark as illustrated in FIG. 29. This prevents the insertion of pages into the booklet assuring that the contents of the booklet are original and permanent.

What is claimed:

1. A Health and Immunization booklet, comprising:
a cover; and
a plurality of water proof pages in said cover, said pages having annotated forms for entering medical history information of a person.

2. The Health and Immunization booklet according to claim 1, wherein said pages include an authenticating watermark.

3. The Health and Immunization booklet according to claim 1, having pages for recording the foot and fingerprints of an infant.

4. The Health and Immunization booklet according to claim 1, wherein said booklet pages are printed with a water proof indelible ink.

5. The Health and Immunization booklet according to claim 1, including an International Certificate of Vaccination against yellow fever.

6. The Health and Immunization booklet according to claim 1, wherein said pages have forms for documenting the medical history of a person beginning at birth.

7. The Health and Immunization booklet according to claim 6, including pages showing family medical history.

8. A Health and Immunization booklet, comprising:
a cover;
a plurality of water proof pages in said cover, said pages having annotated forms for entering medical history information of a person; and
an authenticating watermark on each page.

9. The Health and Immunization booklet according to claim 8, having pages for recording the foot and fingerprints of an infant.

10. The Health and Immunization booklet according to claim 8, wherein said booklet pages are printed with a water proof indelible ink.

11. The Health and Immunization booklet according to claim 8, including an International Certificate of Vaccination against yellow fever.

12. The Health and Immunization booklet according to claim 8, wherein said pages have forms for documenting the medical history of a person beginning at birth.

13. The Health and Immunization booklet according to claim 12, including pages showing family medical history.

14. A Health and Immunization booklet, comprising:
a cover;
a plurality of water proof pages in said cover, said pages having annotated forms for entering medical history information of a person;
an authenticating watermark on each page; and
a plurality of said pages having forms thereon for documenting the medical history of a person beginning at birth.

15. A Health and Immunization booklet, according to claim 1, including pages for recording DNA and cord blood testing, and newborn screening.
